(19) United States
(12) Patent Application Publication
(10) Pub. No.: US 2009/0218444 A1
(43) Pub. Date: Sep. 3, 2009

(54) UNDERCARRIAGE SHOCK ABSORBER WITH POSITIVE RETENTION IN A RETRACTED POSITION AND WITH CRASH OVERTRAVEL

(75) Inventors: Andre Lahargou, Vauhallan (FR); Marc Brune, Pontault Combault (FR); Alain Robuchon, Montlhery (FR)

Correspondence Address: MCCORMICK, PAULDING & HUBER LLP, CITY PLACE II, 185 ASYLUM STREET, HARTFORD, CT, 06103, US

(73) Assignee: MESSIER-DOWTY SA, Velizy Villacoublay (FR)

(21) Appl. No.: 12/091,616

(22) PCT Filed: Oct. 23, 2006
(86) PCT No.: PCT/FR2006/002371

§ 371 Date: Aug. 21, 2008

(30) Foreign Application Priority Data
Oct. 27, 2005 (FR) 0510977

(51) Int. Cl. B64C 25/60

(52) U.S. Cl. 244/102 SL

(57) ABSTRACT

The invention relates to a telescopic shock absorber for an aircraft undercarriage, the shock absorber comprising a strut (1) in which a rod (2) is mounted to slide, the shock absorber including controlled retraction means (41 . . . 43) for retracting the rod into the strut to a retracted position. The shock absorber includes positive retention means (27, 29) for retaining the rod in the strut and adapted to retain the rod in the retracted position when the rod is moved thereto by the retraction means, the positive retention means being arranged, at least in the event of a severe landing of the aircraft, to allow the rod to be pushed into the strut beyond the retracted position.

The invention relates to an undercarriage shock absorber with positive retention in a retracted position and with crash overtravel.

### BACKGROUND OF THE INVENTION

Telescopic shock absorbers are known for the undercarriage of an aircraft, in particular a helicopter, that are constituted by a strut in which a rod is mounted to slide, the shock absorber including controlled retraction means for retracting the rod into the strut to a retracted position.

By way of example, document FR 2 608 242 describes one such shock absorber in which the retracted position is defined by an abutment of the strut. The rod is moved to the retracted position by injecting hydraulic fluid into the annular chamber that extends between the rod and the strut. The rod is then held in the retracted position by keeping the hydraulic fluid captive in the annular chamber.

The abutment is mounted in the strut at the end of a support tube that is suitable for buckling under a force exceeding a predetermined threshold so that in the event of the aircraft crash landing, a compression force is generated on the shock absorber that is greater than said threshold, so the rod deforms the support tube and can thus be pushed into the strut beyond the retracted position.

In the event of hydraulic fluid leaking while the rod is held in the retracted position, the retracted position is no longer guaranteed and the shock absorber lengthens progressively under thrust from the compressed gas contained in the shock absorber and as a function of the volume of fluid that escapes from the annular chamber.

In order to maintain the retracted position even in the event of hydraulic fluid leaking, the precaution has been taken to provide the shock absorber with mechanical means for positively retaining the rod in the retracted position inside the strut. Such positive retention means are well known in the field of actuators comprising a cylinder in which a rod is mounted to slide, with some such actuators being fitted with means for positively retaining the rod in its fully retracted position inside the cylinder. By way of example, such retention means can be constituted by a catch or hook mechanism. In this respect, document GB 561 275 describes means for retaining a rod in a cylinder in a fully pushed-home position, such that those means are arranged in a manner that is not compatible with overtravel beyond the retracted position.

### BRIEF DESCRIPTION OF THE INVENTION

According to the invention, there is provided a telescopic shock absorber for an aircraft undercarriage, the shock absorber comprising a strut in which a rod is mounted to slide, the shock absorber including controlled retraction means for retracting the rod into the strut to a retracted position. According to the invention, the shock absorber is fitted with positive retention means for retaining the rod in the strut and adapted to retain the rod in the retracted position when the rod is moved thereto by the retraction means, the positive retention means being arranged, at least during a severe landing of the aircraft, to enable the rod to be pushed into the strut beyond the retracted position, either by leaving the rod free to slide beyond the retracted position, or by yielding under thrust from the rod.

Thus, the positive retention means as arranged in this way ensure that the rod is held in the retracted position even in the event of hydraulic fluid leaking, but they do not prevent the rod from being pushed into the strut beyond the retracted position.

This thus provides push-in overtravel extending beyond the retracted position that can be used to advantage for absorbing additional energy and thus to reduce the risks associated with a severe landing.

### BRIEF DESCRIPTION OF THE DRAWINGS

The invention can be better understood in the light of the following description with reference to the figures of the accompanying drawings, in which:

FIGS. 1 to 4 are section views of an aircraft shock absorber in a first particular embodiment of the invention, shown in various length positions;

FIG. 5 is a section view of an aircraft shock absorber in a variant embodiment of the invention;

FIG. 6 is a view showing a detail of FIG. 5 concerning means for positive retention of the rod; and

FIG. 7 is a section view of an aircraft shock absorber in a second embodiment of the invention.

### DETAILED DESCRIPTION OF THE INVENTION

With reference to FIG. 1, the shock absorber of the invention comprises in conventional manner a strut 1 having a rod 2 mounted to slide in sealed manner therein.

For this purpose, the strut 1 and the rod 2 carry sealing gaskets 3 that define an annular chamber 4 between the rod 2 and the strut 1.

The strut is subdivided into a bottom chamber 5 and a top chamber 6 by a diaphragm 7 having throttling orifices 8. The bottom chamber 5 extends from the diaphragm 7 to the gasket 3 carried by the rod 2.

A calibration member 9 serves to modify the effective throttling diameter depending on the flow direction of the hydraulic fluid through the throttling orifices 8.

In the position shown in FIG. 1, which is the rest position of the shock absorber, hydraulic fluid fills the bottom chamber 5 and a portion of the top chamber 6. The other portion of the top chamber 6 is subdivided into two gas compartments (here containing nitrogen): a low-pressure compartment 10 in contact with the hydraulic fluid, and a high-pressure compartment 11 separated from the low-pressure compartment 10 by a separator piston 12 that is held against an abutment 13 by the effect of the pressure difference acting thereon.

The rod 2 is hollow and has a top end 14 in the form of a chimney open to the bottom chamber 5 of the strut 1. A plug 15 is mounted to slide in sealed manner in the rod 2 between a bottom abutment and a top abutment to define within the rod a retraction chamber 61 and to isolate the fluid contained in the strut 1 from the fluid contained in the retraction chamber 61.

The bottom end of the rod 2 has a controlled valve 20 that, on being activated, puts the retraction chamber 61 into communication with an external hydraulic circuit. In the rest position shown here, the retraction chamber 61 of the rod 2 is filled with fluid such that the plug 15 is against its top abutment, the valve 20 being kept closed by a spring 21. The plug 15 is then prevented from moving down into the rod 2.

According to the invention, the strut includes a conically-shaped support 25 extending under the diaphragm 7 and carrying a plate 26 that forms an abutment for the rod 2 in the retracted position, as explained below. The plate 26 carries a catch 27 adapted to co-operate with a step 28 carried by the end 14 of the rod 2 in order to hold the rod 2 in its retracted position in the strut 1.

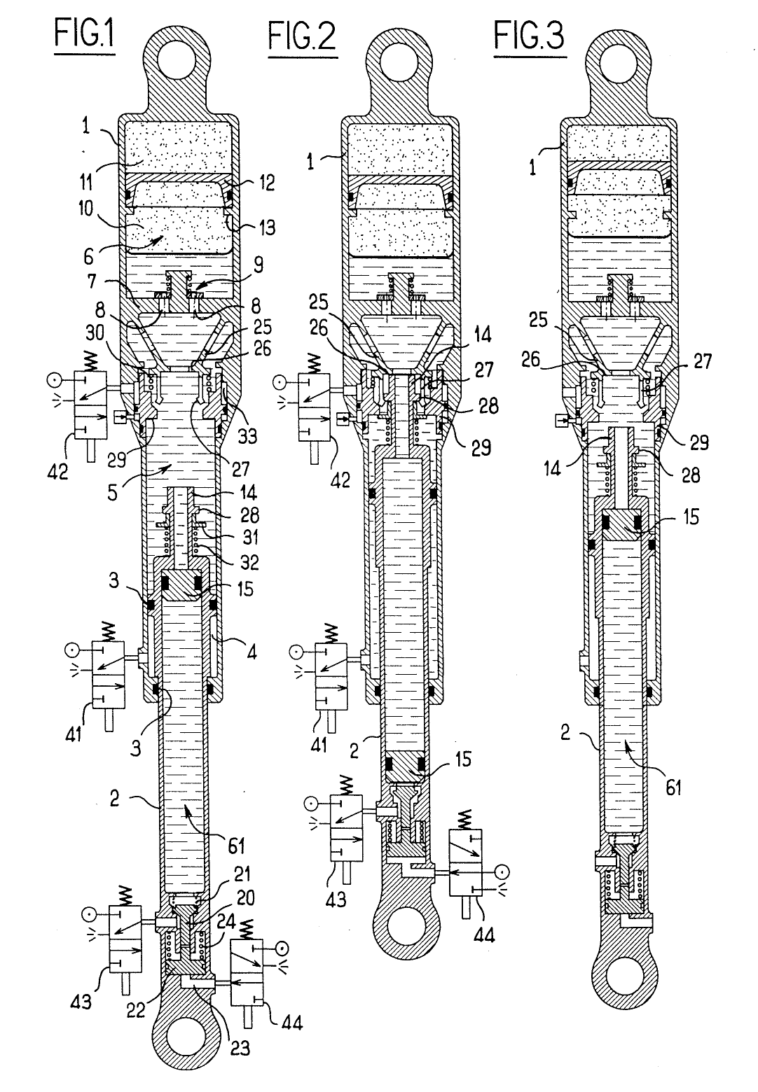

A piston 29 for locking the catch 27 is mounted in the strut to slide axially between the rest position shown in this figure in which it leaves the catch 27 free to expand radially when the step 28 goes past it, and a locking position shown in FIG. 2 in which it prevents the catch from expanding radially so that the catch 27 holds the rod 2 positively.

The locking piston 29 is held in the rest position by a spring 30 extending between the locking piston 29 and the strut 1. When the rod moves to the retracted position, the locking piston 29 is moved into the locking position by a collar 31 slidably mounted on the top end of the rod 2 and held in abutment against the step 28 by a spring 32 that is stiffer than the spring 30.

The locking piston 29 co-operates with the strut 1 to define an annular unlocking chamber 33 that, on being pressurized, forces the locking piston 29 into the rest position.

The operation of the shock absorber shown in FIG. 1 requires four connections with an external circuit, via four selectors, comprising:
a first selector 41 adapted by default to put the annular chamber 4 into communication with the hydraulic return (at a pressure of a few bars) of the aircraft, and when operated, to put the annular chamber 4 into communication with a pressure source of the aircraft (typically at several hundreds of bars);
a second selector 42 adapted by default to put the annular unlocking chamber 33 into communication with the hydraulic return of the aircraft, and when operated, to put the annular unlocking chamber 33 into communication with the pressure source of the aircraft;
a third selector 43 adapted by default to put the inside of the rod 2 into communication with the hydraulic return via the valve 20, and when operated, to put the inside of the rod 2 into communication with the pressure source of the aircraft; and finally
a fourth selector 44 adapted to control the valve 20 via a control piston 22 that co-operates with the rod to define a control chamber 23 and that by default is placed by a spring 24 in a rest position (as shown) in which it does not act on the valve 20. The fourth selector 44 is adapted by default to put the control chamber 23 into communication with the hydraulic return of the aircraft, and when operated, to put the control chamber 23 into communication with the pressure source of the aircraft so that the control piston 22 is moved against the spring 24 to place the valve 20 in the open position.

The shock absorber of the invention is implemented as follows.

Starting from the position shown in FIG. 1, which is the position of the shock absorber once the aircraft has left the ground, it is desired to cause the shock absorber to retract, e.g. for the purpose of minimizing the aerodynamic drag of the associated undercarriage.

For this purpose, and as shown in FIG. 2, the first selector 41 is operated to put the annular chamber 4 into communication with the pressure source of the aircraft. Simultaneously, the fourth selector 44 is operated to put the control chamber 23 into communication with the pressure source of the aircraft, thereby having the effect of opening the valve 20.

The fluid under pressure penetrates into the annular chamber 4, having the effect of moving the rod 2 into the strut 1. This shortening causes the volume of the bottom chamber 5 to be reduced so that some of the hydraulic fluid contained in the bottom chamber 5 is forced to migrate into the rod 2, pushing back the plug 15. The hydraulic fluid contained in the retraction chamber 61 of the rod 2 under the plug 15 is then forced towards the hydraulic return of the aircraft through the open valve 20 and the third selector.

The rod 2 then moves progressively into the strut 1 without the gas compartments 10 and 11 being compressed. Thus, the pressure that exists in the shock absorber never exceeds the inflation pressure of the low-pressure compartment 10.

At the end of the stroke, the step 28 carried by the top end of the rod 2 penetrates into the catch 27 until the top end 14 comes into abutment against the plate 26. The collar 31 moves the locking piston 29 into the locking position, such that the catch can no longer expand and thereby prevents the step 28 from moving back out. The rod 2 is held positively in the retracted position.

The first selector 41 is then released so that the annular chamber is again in communication with the hydraulic return of the aircraft. The fourth selector 44 is also released so as to close the valve 20.

To cause the shock absorber to return to the rest position shown in FIG. 1, the second selector 42 is operated to place the locking piston 29 in its rest position in which it does not oppose radial expansion of the catch 27, and the third selector 43 is operated to put the inside of the rod 2 into communication with the pressure source of the aircraft. Fluid reaches the valve against the spring 21, such that the valve 20 opens automatically without it being necessary to operate the fourth selector 44. The fluid penetrates into the retraction chamber 61 of the rod 2, pushing back the plug 15, which in turn pushes back the hydraulic fluid that has penetrated into the rod 2 from the bottom chamber 5. The fluid pushed back in this way migrates into the bottom chamber 5, thereby having the effect of forcing the rod 2 to be extended from the strut 1. In so doing, the hydraulic fluid contained in the hydraulic chamber 4 is delivered towards the hydraulic return via the first selector 41.

The rod then extends progressively until it reaches its extended abutment. The second selector 42 and the third selector 43 are then returned to the rest position.

In the landing configuration, the shock absorber is in the relaxed position shown in FIG. 1, with all of its selectors being at rest. The plug 15 is then in top abutment within the rod 2 and the retraction chamber 61 is closed by the valve 20. The shock absorber acts as though the plug 15 forms a barrier for the fluid contained in the bottom chamber 5 so that fluid cannot penetrate into the rod 2.

As can be seen in FIG. 3, pushing the rod 2 into the strut 1 under the effect of landing forces then causes fluid to be transferred from the bottom chamber 5 towards the top chamber 6 through the throttling orifices 8, which orifices give rise to high levels of head loss, thereby slowing down the movement of the rod 2 into the strut 1.

The fluid as transferred in this way reduces the volume available for the gas in the top chamber 6, such that at least the low-pressure gas compartment 10 becomes compressed. As soon as the pressure in the low-pressure gas compartment 10 reaches or exceeds the inflation pressure of the high-pressure gas compartment 11, the high-pressure compartment is in turn compressed.

The annular chamber 4 remains connected to the hydraulic return of the aircraft, such that it remains continuously under pressure and no cavitation occurs therein.

During ordinary landings, the mechanical impact energy to be absorbed in order to stop the downward movement of the aircraft can be absorbed (by heat being generated during throttling of the fluid or by compression of the gas compartments) over a compression stroke of the rod into the strut that is such that the rod remains below the retracted position shown in FIG. 2.

Nevertheless, in the event of a severe landing, e.g. a crash landing at a very high vertical speed, such a strut is not sufficient for absorbing the mechanical energy of the impact.

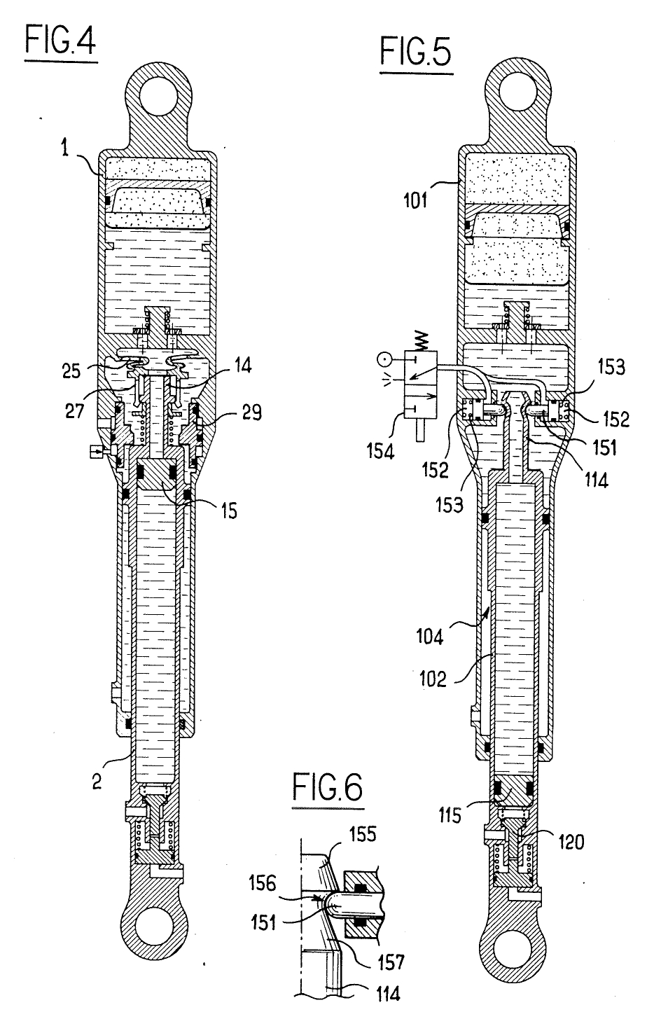

Under such situations, and as shown in FIG. 4, the rod 2 reaches the retracted position, exerting a force on the abutment 26 that is greater than the deformation threshold of the conical support 25 such that it deforms and the rod 2 continues moving into the strut 1, taking the plate 26 and the catch 27 with it. Simultaneously, the collar 31 comes to bear against the locking piston and then yields, not opposing movement of the rod 2 beyond the retraced position.

This thus releases a certain amount of crash overtravel beyond the retracted position whereby additional mechanical energy can be absorbed by throttling hydraulic fluid and compressing the gas compartments (not counting the mechanical energy that is absorbed by deforming the conical support 25).

Thus, in accordance with the invention, the means for positively retaining the rod in the retracted position are adapted to allow the rod 2 to be pushed into the strut 1 beyond the retracted position.

This possibility of going beyond the retracted position relies in particular in the elements of the positive retention means that are carried away by the rod (catch, step, abutment, collar) being capable of sliding without jamming (or while yielding) relative to the elements of the positive retention means that remain stationary relative to the strut (locking piston).

With reference to FIG. 5 and in a shock absorber similar to that shown in FIGS. 1 to 4, one possible variant embodiment of the invention consists in replacing the overridable catch mechanism with a retractable finger mechanism. In FIG. 5, elements that are common with elements of FIGS. 1 to 4 are given the same numerical references plus one hundred.

The strut 101 carries two fingers 151 that are slidably mounted in housings 152 to move in a direction perpendicular to the direction in which the rods 201 slide in the strut 101. The fingers 151 are urged by springs 153 into a latching position as shown in which the fingers project from the housings 152.

The fingers 151 are associated with pistons mounted to slide in sealed manner in the housings 152 and defining therein respective annular chambers that can be put into communication with the pressure source of the aircraft via a selector 154 so as to cause the fingers 151 to be retracted against the springs 153.

The fingers 151 are designed to co-operate with the top end 114 or the rod 102 in order to hold it positively in the retracted position, as shown here.

As can be seen more clearly in FIG. 6, the top end 114 has a conical first portion 115 that, on going past the fingers 151, forces the fingers to retract into the housings 152 against the springs 153.

The conical portion 155 is followed by a groove 156 into which the fingers are pushed by the springs 153, as shown in FIG. 6. The fingers 151 then hold the rod 102 positively in the retracted position. To release the rod 102, the selector 154 is operated to retract the fingers 151 and allow the rod 102 to move downwards.

Unlike the shock absorber shown in FIGS. 1 to 4, it should be observed that here there is no abutment for defining the retracted position of the rod. This position is defined by the fingers 151 engaging in the groove 156. This engagement can be identified by a finger position sensor (not shown) that changes the value of an output signal when engagement occurs, which change is advantageously used to stop feeding fluid to the annular chamber 104 and to close the valve 120.

The groove 156 is followed by a conical portion 157 extending the surface defining the wall of the groove 156. In the event of a severe landing, the rod tends to be pushed further into the strut and the conical portion 156 forces the fingers 151 to retract into the housings 152 against the springs 153. The rod 102 can then move beyond the retracted position without the positive retention means opposing this movement.

The shock absorber thus presents a retracted position that is guaranteed by the positive retention means constituted by the fingers 151, while also presenting overtravel beyond the retracted position in the event of a severe landing.

Unlike the above-described embodiment (and also the embodiment described below), pushing the rod beyond the retracted position does not require an internal part of the shock absorber to be broken or deformed.

This possibility of moving beyond the retracted position relies in particular on the elements of the positive retention means that are entrained by the rod (groove 156) being capable of sliding without jamming relative to the elements of the positive retention means (fingers) that do not move along the strut.

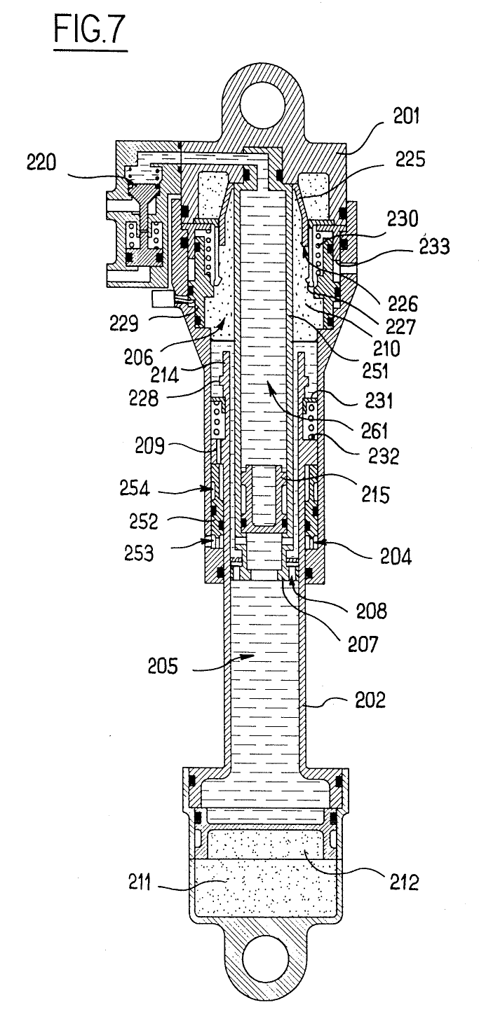

In a second embodiment shown in FIG. 7, modifications are made to a shock absorber of the inverted type, e.g. as described in document EP 0 533 530, so as to fit it with overridable positive retention means of the invention.

The shock absorber comprises a strut 201 in which a rod 202 is mounted to slide in sealed manner. As above, the strut 201 and the rod 202 define an annular chamber 204.

The shock absorber includes a dip tube 251 that extends inside the rod and that carries at its bottom end a diaphragm 207 separating a bottom chamber 205 filled with hydraulic fluid and extending in the rod 202 under the diaphragm 207 from a top chamber 206 extending above the diaphragm 207 in the strut 201.

The top chamber 206 is partially filled with hydraulic fluid, with the remaining space forming a low-pressure gas compartment 210. A high-pressure gas compartment 211 extends in the bottom end of the rod 2, being separated from the hydraulic fluid by a separator piston 212.

The annular chamber 204 is split into two by a floating piston 252 that subdivides the annular chamber into a thrust chamber 253 and a relaxation chamber 254.

The diaphragm 207 has throttling orifices 208 for allowing hydraulic fluid to be transferred between the bottom chamber 205 and the top chamber 206. Similarly, the rod 202 has throttling orifices 209 for allowing hydraulic fluid to be transferred between the top chamber 206 and the relaxation chamber 254.

During shortening while landing, fluid is transferred from the bottom chamber 205 towards the top chamber 206 via the orifices 208 that give rise to high levels of head loss, slowing down the movement of the rod 202 into the strut 201. In parallel, fluid is transferred from the top chamber 206 towards the relaxation chamber 254.

The fluid as transferred in this way reduces the volume available for gas in the top chamber 206 such that at least the low-pressure gas compartment 210 is compressed. Once the pressure in the bottom chamber 205 reaches or exceeds the inflation pressure of the high-pressure gas compartment 211, the high-pressure compartment is compressed in turn.

The dip tube 251 defines a retraction chamber 261 that is closed by a plug 215 slidable in leaktight manner in the dip tube 251. The retraction chamber is closed by a controlled valve 220.

In the same manner as for the shock absorber shown in FIGS. 1 to 4, in order to move the rod 202 into the retracted position, hydraulic fluid is admitted into the thrust chamber 253 and the controlled valve 220 is opened to allow the fluid contained in the retraction chamber 251 to escape.

The strut 201 has an abutment 226 carried by a conical structure 225. The abutment 226 co-operates with the top end 214 of the rod 202 in order to define the retracted position.

According to the invention, the strut is fitted with a catch 227 that extends to co-operate with a step 228 carried by the top end 214 of the rod 202. A locking piston 229 is mounted to slide in the strut between a rest position (as shown) in which it leaves the catch 227 free to expand radially when the step 228 goes past it, and a locking position in which it prevents such expansion so that the catch 227 positively retains the rod 202.

The locking piston 229 is held in the rest position by a spring 230 that extends between the locking piston 229 and the strut 201. The locking piston 229 is moved into the locking position by a collar 231 that is slidably mounted on the top end 214 of the rod 202 and that is held in abutment against the step 228 by a spring 232 that is stiffer than the spring 230.

The locking piston 229 co-operates with the strut 1 to define an annular unlocking chamber 223 that, on being pressurized, forces the unlocking piston 229 into the rest position.

This shock absorber operates in entirely similar manner to the shock absorber shown in FIGS. 1 and 2, so its operation is not described again in detail below.

In the event of a severe landing, e.g. in the event of a crash, the top end 214 of the rod 202 bears against the abutment 226 and deforms the conical structure 225 so that the rod can continue to be pushed in beyond the retracted position. It should be observed that unlike the shock absorber shown in FIGS. 1 to 4, the catch 227 is not secured to the abutment 226, such that the catch 227 is not entrained by the rod 202 when it moves beyond the retracted position.

Once more, the possibility of being pushed in beyond the retracted position relies in particular on the elements of the positive retention means that are carried away by the rod (step, abutment, collar) being capable of sliding without jamming (or while yielding) relative to the elements of the positive retention means that remain stationary relative to the strut (catch, locking piston).

The invention is not restricted to the above description, but on the contrary covers any variant coming within the ambit defined by the claims.

In particular, although the invention is shown in an application to shock absorbers having two gas compartments, this example is not limiting and the invention can be applied in the same manner to shock absorbers having only one, or on the contrary having more than two gas compartments.

Although in the examples shown, the controllable portion of the positive retention means (catch/piston or finger/spring) is placed inside the strut while the passive portion of the positive retention means (step or groove) is placed on the rod, it would naturally be possible to invert that arrangement and place the controllable portion of the positive retention means on the rod and the passive portion of the positive retention means in the strut.

Furthermore, although in the examples shown, the rod is locked in the retracted position in purely passive manner, with only unlocking being a controlled action, it would be possible to use positive retention means that need to be activated in order to retain the rod.

What is claimed is:

1. A telescopic shock absorber for an aircraft undercarriage, the shock absorber comprising a strut (1; 101; 201) in which a rod (2; 102; 202) is mounted to slide, the shock absorber including controlled retraction means (41 . . . 43) for retracting the rod into the strut to a retracted position,
the shock absorber including positive retention means (27, 29; 152, 153; 227, 229) for retaining the rod in the strut and adapted to retain the rod in the retracted position when the rod is moved thereto by the retraction means, the positive retention means being arranged, at least during a severe landing of the aircraft, to enable the rod to be pushed into the strut beyond the retracted position either by leaving the rod free to slide beyond the retracted position, or by yielding under thrust from the rod.

2. A shock absorber according to claim 1, in which the shock absorber includes an abutment (26; 226) defining the retracted position of the rod in the strut that is associated with means (25; 225) enabling it to be overridden by thrust from the rod against the abutment in the event of a severe landing of the aircraft.

3. A shock absorber according to claim 2, in which the means for overriding the abutment (26; 226) comprise a deformable structure (25; 225).

4. A shock absorber according to claim 2, in which the positive retention means comprise, on one of the rod and strut elements, a catch (27; 227) associated with a locking piston (29; 229), and on the other one of the rod and strut elements, a step (28; 228) adapted to co-operate with the catch to retain the rod positively in the retracted position.

5. A shock absorber according to claim 4, in which the catch (27) is mounted on the strut, being secured to the abutment (26), such that the catch follows the rod when the rod is pushed in beyond the retracted position.

6. A shock absorber according to claim 4, in which the catch (227) is mounted on the strut independently of the abutment (226) such that the catch remains stationary while the rod is being pushed in beyond the retracted position.

7. A shock absorber according to claim 1, in which the positive retention means comprise fingers (151) mounted to slide on the strut perpendicularly to a sliding direction of the rod, and urged by springs towards a latching position in which they are suitable for co-operating with a top end of the rod to retain it in the retracted position.

8. A shock absorber according to claim 7, in which the end of the rod comprises in succession:
a first conical portion (155);
a groove (156) for receiving the fingers when the rod is in the retracted position; and
a second conical portion (157) extending a surface defining a wall of the groove in such a manner that in the event of a severe landing, the fingers are pushed back by said second conical portion.
